(19) United States
(12) Patent Application Publication
(10) Pub. No.: US 2014/0376205 A1
(43) Pub. Date: Dec. 25, 2014

(54) PHOSPHOR AND LIGHT-EMITTING DEVICE USING THE SAME

(71) Applicant: PANASONIC CORPORATION, Osaka (JP)

(72) Inventor: Toshiyuki TAKIZAWA, Kyoto (JP)

(21) Appl. No.: 14/481,604

(22) Filed: Sep. 9, 2014

Related U.S. Application Data
(63) Continuation of application No. PCT/JP2013/001441, filed on Mar. 7, 2013.

(30) Foreign Application Priority Data
Mar. 12, 2012 (JP) 2012-054814

(51) Int. Cl. F21K 99/00; C09K 11/77

(52) U.S. Cl. CPC F21K 9/56; C09K 11/77
USPC 362/84; 252/301.4 R; 252/301.6 R

(57) ABSTRACT

A phosphor according to the present disclosure is obtained by adding a rare earth element to a host material having boron, nitrogen, and oxygen as main components, and a composition formula is represented by B(l)O(m)N(n):Z. Here, B, O, N, and Z indicate boron, oxygen, nitrogen, and the rare earth element, respectively. Moreover, each of l, m, and n indicates element content.

### CROSS REFERENCE TO RELATED APPLICATIONS

This is a continuation application of PCT International Application No. PCT/JP2013/001441 filed on Mar. 7, 2013, designating the United States of America, which is based on and claims priority of Japanese Patent Application No. 2012-054814 filed on Mar. 12, 2012. The entire disclosures of the above-identified applications, including the specifications, drawings and claims are incorporated herein by reference in their entirety.

### FIELD

The present disclosure relates to a light-emitting device used as a light source in a lighting device such as interior lighting and headlights of a vehicle, or a light-emitting device used as a light source in a display such as a projector or a smartphone, and relates to a phosphor used in the light-emitting device.

### BACKGROUND

Recent years have seen active development of a light-emitting device that combines a semiconductor light-emitting element having an emission wavelength of emitted light of 380 nm to 480 nm (ultraviolet to blue) and a phosphor that absorbs part of the emitted light and emits fluorescence having a wavelength longer than that of the emitted light. Among them, a white light-emitting diode that combines a nitride semiconductor light-emitting diode emitting blue light and a phosphor emitting yellow fluorescence is rapidly replacing the existing incandescent light bulb and fluorescent lamp since the white light-emitting device has power conversion efficiency higher than that of the existing incandescent light bulb and fluorescent lamp.

As a typical phosphor material comprising this white light-emitting diode, for example, Patent Literature 1 (PTL 1) reports a cerium (Ce)-activated yttrium aluminum garnet phosphor represented by general formula (Y,Gd)₃(Al,Ga)₅O₁₂:Ce³⁺. Since this yttrium aluminum garnet phosphor has high conversion efficiency but uses fluorescence by 4f-5d transition of activated cerium, there are characteristics that the full width at half maximum of fluorescence spectrum is wide and much light in a region having significantly low visual sensitivity in a wavelength of at least 660 nm is emitted.

Meanwhile, there are proposed a variety of combinations regarding a light-emitting device that combines this semiconductor light-emitting element and phosphor as the light-emitting device is applied to various purposes.

For example, Patent Literature 2 (PTL 2), Non Patent Literature 1 (NPL 1), and the like report that in a white light-emitting diode for a display light source, in order to separate the light from a white light-emitting diode into blue (B), green (G), and red (R), europium (Eu) activated orthosilicate phosphor (general formula (Sr,Ba)₂SiO₄:Eu) that emits fluorescence having a high color purity of green is used, and a phosphor comprising europium activated CaAlSiN₃ crystal (general formula CaAlSiN₃:Eu) is used as a phosphor having high color purity of red.

Moreover, for example, in NPL1, there is proposed a white light-emitting diode that combines a light-emitting diode emitting ultraviolet, and red, green and blue phosphors.

Moreover, in Patent Literature 3 (PTL 3) or Patent Literature 4 (PTL 4), there is proposed a configuration in which a phosphor is used in a light-emitting device of a projection display device. The following will describe a conventional light-emitting device with reference to FIG. 10.

As illustrated in FIG. 10, the conventional light-emitting device includes a light-emitting diode 1001 that emits ultraviolet and a color wheel 1002 in which a phosphor layer including red, green, and blue phosphors is disposed in each divided region. By rotating the color wheel 1002, the light emitted from the light-emitting diode 1001 is sequentially changed between red, green, and blue, and the light-emitting device is driven such that white light is emitted when observed in time average. In this configuration, it is disclosed that as a green phosphor, ZnS:Cu,Al, (Ba,Mg)Al₁₀O₁₇:(Eu,Mn), or Y₃(Al,Ga)₅O₁₂:Ce³⁺is used.

### CITATION LIST

### Patent Literature

[PTL 1] U.S. Pat. No. 5,998,925

[PTL 2] Japanese Unexamined Patent Application Publication No. 2005-235934

[PTL 3] Japanese Unexamined Patent Application Publication No. 2004-341105

[PTL 4] Japanese Unexamined Patent Application Publication No. 2011-053320

### Non Patent Literature

[NPL 1] “White LED Materials for Next-Generation Lighting”, Noboru Ichinose et al., Nikkan Kogyo Shinbun Ltd., pp. 83 to 125

### SUMMARY

### Technical Problem

However, there is a problem related to a green phosphor in the aforementioned light-emitting device.

First, there is a problem that since the emission wavelength center of a cerium-activated yttrium aluminum garnet phosphor is located in a yellow region as described above, the color purity of green is not sufficient for a green phosphor for a display device and color reproducibility is low, and that since the full width at half maximum of the emission spectrum is wide, a conversion loss occurs in a region having low visual sensitivity and therefore the efficiency is low.

Moreover, a europium-activated orthosilicate phosphor or (Ba,Mg)Al₁₀O₁₇:Eu,Mn has a spectrum having a narrow full width at half maximum, alkaline earth metals (Ba, Mg) are included as a host material. This means that it is vulnerable to water and durability is low.

Moreover, since ZnS:Cu,Al is a sulfide, there is a problem that durability is low due to an increase of crystal defects.

The present disclosure is conceived to solve the aforementioned problem, and an object of the present disclosure is to provide a high efficient phosphor having high color reproducibility and having small light emission in a region having low visual sensitivity. Furthermore, the object is also to provide, by using the phosphor, a light-emitting device having high color rendering properties and high color reproducibility.

Moreover, from another perspective of the present disclosure, the object is to easily manufacture a phosphor having high nitrogen content by increasing reactivity compared with a nitriding process using a conventional nitrogen gas.

### Solution to Problem

In order to solve the aforementioned problem, in a phosphor according to the present disclosure, rare earth element is added to a host material containing boron, nitrogen, and oxygen as main components, and the central fluorescence wavelength is a green region.

With this, since without using alkaline earth metal, the emission spectrum in which central fluorescence wavelength is a green region and full width at half maximum is narrow can be obtained, it is possible to realize a high efficient phosphor having high durability, high and excellent color reproducibility with high color purity of green, and small light emission in a region having low visual sensitivity.

Furthermore, in the phosphor according to the present disclosure, a rare earth element is at least one element selected from a group consisting of elements with atomic numbers from 58 to 71.

With this, without changing the host material, it is possible to express various fluorescent colors.

Furthermore, in the phosphor according to the present disclosure, the host material includes, as an accessory component, at least one element selected from a group consisting of Al, Si, C, P, S, Mg, Ca, Sr, Ba, and Zn.

With this, it is possible to control absorption spectrum of the host material. Moreover, since the bonding state around the rare earth element can be changed, it is possible to fine-tune the fluorescence spectrum.

Furthermore, in the phosphor according to the present disclosure, along with a rare earth element, at least one element selected from a group consisting of Sc, Y and La is added to the host material.

With this, since a rare earth element can convert excitation energy, it is possible to increase conversion efficiency.

Furthermore, in the phosphor according to the present disclosure, the phosphor has a main fluorescence wavelength from 500 nm to 590 nm.

With this, it is possible to convert light having low visual sensitivity of 350 nm to 490 nm to light having high visual sensitivity.

Moreover, a light-emitting device according to the present disclosure is a light-emitting element having a main light emission wavelength from 350 nm to 490 nm; and a phosphor member, wherein the phosphor member includes any of the aforementioned phosphors.

With this, it is possible to realize a light-emitting device that emits green light having high color reproducibility.

Furthermore, in the phosphor according to the present disclosure, the phosphor member further includes, as a second phosphor, a phosphor having a main fluorescence wavelength from 590 nm to 660 nm.

With this, it is possible to realize a light-emitting device that emits light having high color reproducibility.

Furthermore, in the light-emitting device according to the present disclosure, the phosphor member further includes, as a third phosphor, a phosphor having a main fluorescence wavelength from 430 nm to 500 nm.

With this, it is possible to realize a light-emitting device that emits light having high color reproducibility.

Furthermore, in the light-emitting device according to the present disclosure, the phosphor member has one or more regions divided according to a type of the included phosphor.

With this configuration, it is possible to realize a light-emitting device that emits light having high color reproducibility at every time.

Furthermore, in the light-emitting device according to the present disclosure, the second phosphor is obtained by dissolving Si₂N₂O in a quantum dot phosphor, CaAlSiN₃:Eu, (Sr,Ca)AlSiN₃:Eu, or CaAlSiN₃:Eu.

With this, it is possible to realize a light-emitting device having high color reproducibility.

Furthermore, in the light-emitting device according to the present disclosure, the third phosphor is any one of (Ba,Sr)MgAl₁₀O₁₇:Eu, (Sr,Ca,Ba,Mg)₁₀,(PO₄)₆Cl₂:Eu, and (Sr,Ba)₃MgSi₂O₈:Eu.

With this, it is possible to realize a light-emitting device having high color reproducibility.

Furthermore, in the light-emitting device according to the present disclosure, a light-emitting element is a semiconductor laser diode.

With this, it is possible to realize a light-emitting device having high color reproducibility by performing color conversion on laser light.

Furthermore, the phosphor according to the present disclosure has a feature that by having a nitriding process as a manufacturing procedure and by using urea as a nitrogen raw material in the nitriding process, the nitrogen content concentration is increased compared with that of the raw material.

With this, it is possible to easily manufacture a phosphor having high nitrogen content at low temperature and low pressure, by increasing reactivity compared with that using the nitriding process using a conventional nitrogen gas. Moreover, different from the nitriding process using a conventional ammonia gas, a gas supplying facility is not necessary. Therefore, it is possible to manufacture a phosphor at low price and having high nitrogen content.

In this case, the phosphor is represented by chemical formula MO(₁₋ₓ)Nₓ:RE. Here, M is at least one element selected from a group consisting of elements in Group IIA, Group IIIA, and Group IIIB, nitrogen composition x is a value that is larger than 0 and is not larger than 1, and RE is at least one element selected from a group consisting of elements with atomic numbers from 58 to 71.

### Advantageous Effects

According to the present disclosure, since a phosphor does not include an alkaline earth metal and comprises a material including an oxide and a nitride, it is possible to realize a phosphor having high durability, high color purity, and high efficiency.

Furthermore, by using the phosphor, it is possible to realize a light-emitting device having high color rendering properties and high color reproducibility.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure.

FIG. 1 is a diagram illustrating an excitation spectrum and emission spectrum in a phosphor according to Embodiment 1.

FIG. 2 is a diagram illustrating an emission spectrum of a phosphor according to Embodiment 1 (addition of Eu to BON), and an emission spectrum of a phosphor in a comparative example (no addition of BON to Eu).

FIG. 3 is a diagram for explaining an influence of annealing temperature in a phosphor according to Embodiment 1.

FIG. 4 is a diagram for explaining a boric acid ratio dependence in a phosphor according to Embodiment 1.

FIG. 5A is a diagram illustrating a configuration of a light-emitting device according to Embodiment 2.

FIG. 5B is an elevation view illustrating a front view of a phosphor wheel used in a light-emitting device according to Embodiment 2.

FIG. 6 is a diagram for explaining a combination of phosphors used in a phosphor wheel according to Embodiment 2.

FIG. 7A is a diagram illustrating a spectrum when a green phosphor emits light, in a light-emitting device according to Embodiment 2.

FIG. 7B is a diagram illustrating a spectrum when a blue phosphor emits light, in a light-emitting device according to Embodiment 2.

FIG. 7C is a diagram illustrating a spectrum when a red phosphor emits light, in a light-emitting device according to Embodiment 2.

FIG. 7D is a diagram illustrating a spectrum when a white phosphor emits light, in a light-emitting device according to Embodiment 2.

FIG. 7E is a diagram plotting chromaticity coordinates for respective colors in FIGS. 7A to 7D in a light-emitting device according to Embodiment 2.

FIG. 8A is a diagram illustrating a configuration of an emission spectrum of a light-emitting device (white light-emitting diode) according to Embodiment 3.

FIG. 8B is a diagram illustrating a color rendering index of a light-emitting device (white light-emitting diode) according to Embodiment 3.

FIG. 9A is a diagram illustrating an emission spectrum of a light-emitting device (white light-emitting diode) according to Modification to Embodiment 3.

FIG. 9B is a diagram illustrating a color rendering index of a light-emitting device (white light-emitting diode) according to Modification of Embodiment 3.

FIG. 10 is a diagram for explaining a configuration of a conventional light-emitting device.

### DESCRIPTION OF EMBODIMENTS

The following will describe a phosphor, a method of manufacturing the phosphor, and a light-emitting device using the phosphor according to embodiments with reference to the Drawings. It should be noted that the embodiments to be described later are mere examples. The numerical values, shapes, materials, structural elements, the arrangement and connection of the structural elements, steps, the processing order of the steps etc. shown in the following exemplary embodiments are mere examples, and therefore do not limit the present disclosure. Therefore, among the structural elements in the following exemplary embodiments, structural elements not recited in any one of the independent claims defining the most generic part of the inventive concept are described as arbitrary structural elements.

### Embodiment 1

A phosphor according to Embodiment 1 (hereinafter referred to as the phosphor) is obtained by adding a rare earth element to a host material containing boron, nitrogen, and oxide as main components. The phosphor comprises a host material comprising boron oxynitride (BON) and an additive comprising a rare earth element, and its composition formula is represented by B(l)O(m)N(n):Z. Here, B, O, N, and Z indicate boron, oxygen, nitrogen, and a rare earth element, respectively. Moreover, each of l, m, and n indicates an element content. In the present embodiment, a rare earth element to be added to BON is europium (Eu), for example.

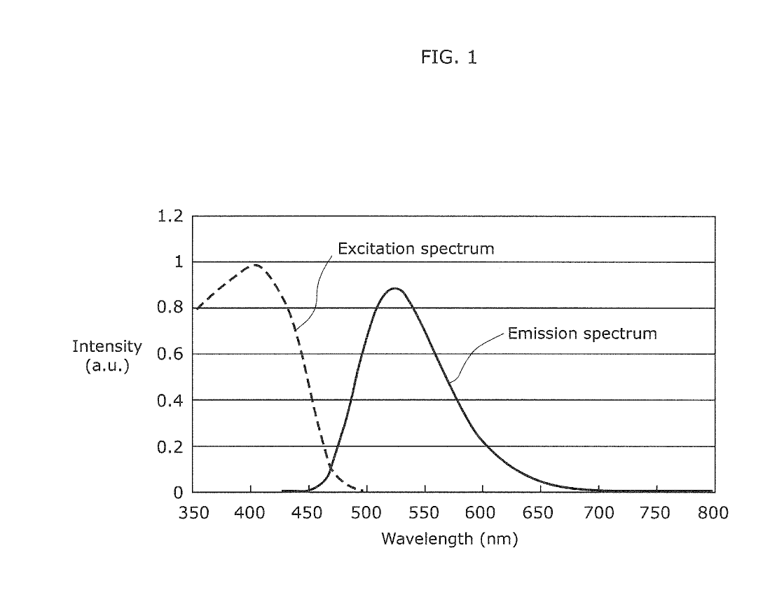

FIG. 1 is a diagram illustrating an excitation spectrum and emission spectrum in a phosphor according to Embodiment 1. It should be noted that the phosphor illustrated in FIG. 1 is BON:Eu, and is manufactured based on a manufacturing method in the present embodiment to be described later.

As illustrated in FIG. 1, it is found that the phosphor has an excitation spectrum in a wavelength range of 350 nm to 490 nm. Moreover, it is found that the phosphor has an emission spectrum having a central fluorescence wavelength (main fluorescent wavelength) of about 520 nm, and a full width at half maximum of about 70 nm. As described above, it is found that by excitation light of 350 nm to 490 nm, the phosphor emits light having an emission spectrum in which central fluorescence wavelength is a green region and a full width at half maximum is narrow.

Furthermore, the phosphor has chromaticity coordinates (0.298, 0.582), and the characteristics almost the same as chromaticity coordinates (0.3, 0.6) that are green of sRGB according to an international standard set by the International Electrotechnical Commission. In other words, the phosphor has a high color purity of green. Furthermore, the phosphor has characteristics that there is almost no emission spectrum in a wavelength of 650 nm or more that is beyond the human visual range. In other words, the phosphor has low light emission in a region having low visual sensitivity and has high conversion efficiency. As described above, the phosphor functions as a phosphor having high color rendering near pure green and high efficiency.

Next, a method of manufacturing the phosphor according to Embodiment 1 will be described.

First, as a raw material, boric acid, urea, and europium nitrate hexahydrate are prepared. All of them are white powder. Among these raw materials, boric acid, as suggested by chemical formula H₃BO₃, works as a supply source of boric oxide. Moreover, urea is defined by chemical formula (NH₂)₂CO, and is thermally decomposed into NH₂ group and CO by the application of heat. Among them, NH₂ group has a chemical reaction with boric oxide, and then becomes boron oxynitride that is a host material of the phosphor. As described above, by adding urea and by applying heat, the oxide of the raw material is easily changed to oxynitride having high nitrogen content. Meanwhile, europium nitrate hexahydrate functions as a supply source of europium that is the luminescence center. This substance is surrounded by nitro group, and part of the nitro group is volatilized as NOₓ. The remaining europium oxide nitride is incorporated into boron oxynitride that is a host material. Since europium nitrate hexahydrate is less than boric acid and urea, it is difficult to measure. Therefore, first, it should be hydrated and then fabricated in 0.5 M solution.

When the phosphor is manufactured on a low-volume basis, preparation for each raw material can be made as follows. First, 0.5 gram of boric acid, 4.64 grams of urea, 0.81 cc of europium nitrate hexahydrate solution are prepared, and then these are put into a beaker. Furthermore, by adding 10 cc of pure water and then stirring, a mixture (solution) comprising boric acid, urea, europium nitrate hexahydrate solution, and pure water is prepared. At this time, although urea has high water solubility and is quickly hydrated, the hydration of boric acid is induced by endothermic reaction and the whole of boron cannot be hydrated at normal temperature. Therefore, it is desirable that the mixture is heated. For example, by heating on a hot plate, all of the boric acid is hydrated. It should be noted that the mixture after hydration becomes transparent liquid.

Next, after all of the boron is hydrated, a beaker containing the mixture is heated and water is gradually evaporated. As the water is evaporated, the mixture (solution) turns white. After the water is sufficiently evaporated, white powder remains.

Next, the white powder is collected and then annealing is performed on the white powder by setting the white powder on an electric furnace. The annealing is performed at temperature of 1400° C. for two hours. The atmosphere in the furnace is nitrogen gas and at normal pressure. With this, although there is the white powder before the annealing, there is yellow phosphor powder after the annealing. As described above, the white powder before the annealing is changed into yellow phosphor powder by the annealing.

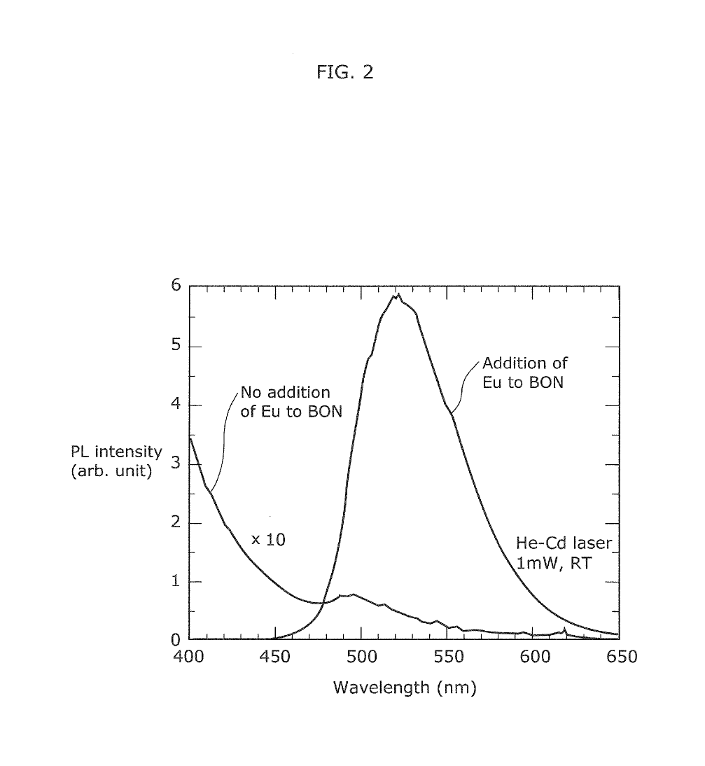

Next, the light emission characteristics of the phosphor will be described when the condition for manufacturing the phosphor is changed, with reference to FIGS. 2 to 4.

First, an experiment on the presence or absence of the addition of Eu to boron oxynitride (BON) was conducted to consider what brings green emission in the phosphor. FIG. 2 is a diagram illustrating an emission spectrum of a phosphor according to Embodiment 1 (addition of Eu to BON), and an emission spectrum of a phosphor in a comparative example (no addition of Eu to BON).

As obvious from FIG. 2, when Eu is added as the phosphor (addition of Eu), green emission and the same emission spectrum as that in FIG. 1 are observed. Meanwhile, when Eu is not added (no addition of Eu), green emission is not observed and only light emission is observed in a near-ultraviolet region. Moreover, it is found that the light emission in this near-ultraviolet region is caused by boron oxynitride (BON) that is a host material.

As described above, only boron oxynitride is not sufficient to obtain green emission in the phosphor. It is found that the addition of Eu as the luminescence center is necessary.

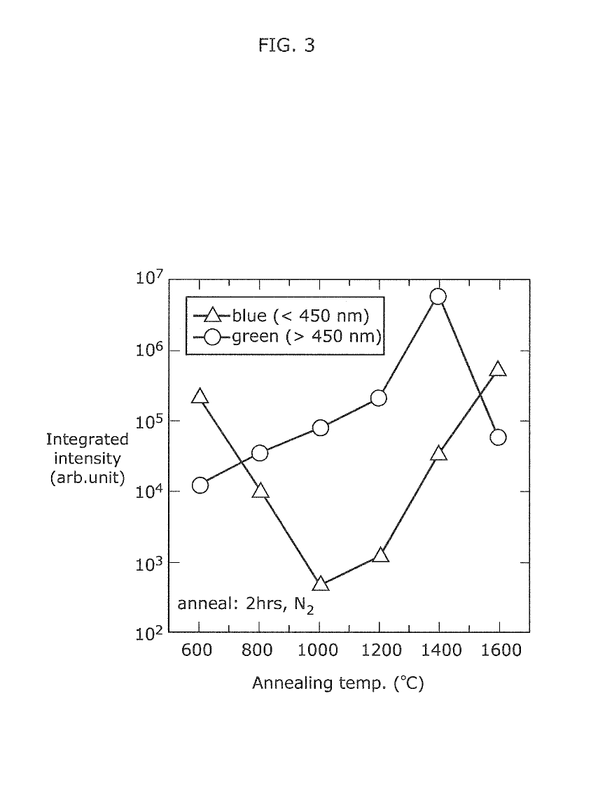

Next, a change in luminescence intensity when the annealing temperature is changed in manufacturing the phosphor will be described with reference to FIG. 3. FIG. 3 is a diagram for explaining an influence of annealing temperature (annealing temperature dependence) in the phosphor according to Embodiment 1, and illustrates a relationship between the annealing temperature and luminescence intensity. It should be noted that in this assessment, He—Cd laser having wavelength of 325 nm and output of 1 mW is used as excitation light source, and measurement is performed at room temperature. Moreover, the luminescence intensity is divided into less than 450 nm in wavelength (“blue” in A in FIG. 3) and no less than 450 nm in wavelength (“green” in 0 in FIG. 3), and then is calculated by combining in each wavelength range. Moreover, the experiment was conducted by setting the annealing temperature in increments of 200° C. from 600° C. to 1600° C.

As illustrated in FIG. 3, it is found that when the annealing temperature is no more than 600° C., light emission having less than 450 nm is dominant. A peak wavelength of this light emission is a near-ultraviolet region having around 350 nm. As illustrated also in FIG. 2, this is light emission originating from boron oxynitride (BON) that is a host material. This is because it is believed that since Eu is not well incorporated into the host material, green emission as illustrated in FIG. 1 can be sufficiently obtained.

Moreover, as illustrated in FIG. 3, it is found that when the annealing temperature is increased to 800° C. or more, light emission having no less than 450 nm is gradually intense while light emission having less than 450 nm is suppressed. This is because it is believed that since by being provided with sufficient thermal energy, Eu is well incorporated into boron oxynitride that is a host material, and green emission by Eu is dominant. Especially at an annealing temperature of 1400° C., it is found that the largest luminescence intensity is obtained.

Moreover, when the annealing temperature is further increased, it is found that green emission is rapidly decreased at 1600° C. and the intensity of near-ultraviolet emission is increased again. This is because it is believed that since the annealing temperature is high and then a chemical structure surrounding Eu and necessary for light emission is broken, the light emission from boron oxynitride that is a host material becomes intense again.

It is found that in order to obtain good green emission, it is found that it is beneficial to perform annealing at the most appropriate temperature. It should be noted that although in this experiment, annealing is performed in a nitrogen atmosphere, there is a possibility that high efficient green emission can be obtained at a high temperature by performing annealing while introducing oxygen.

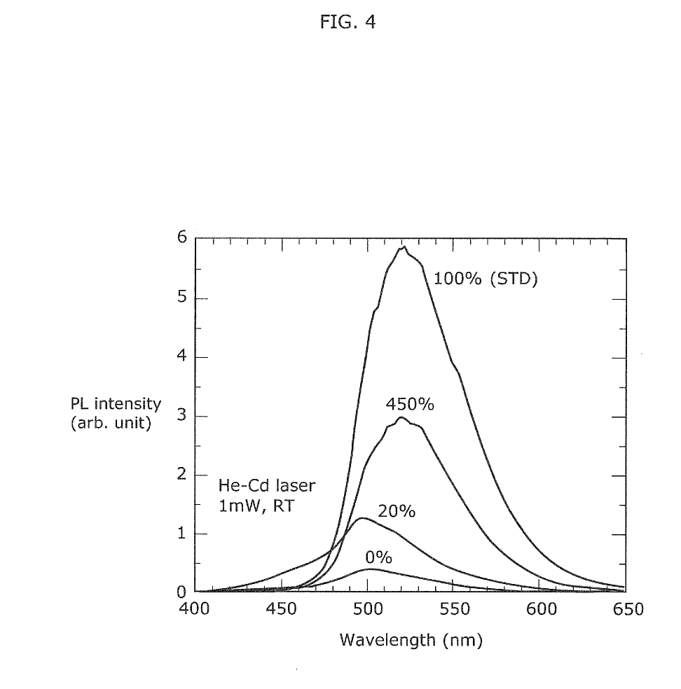

Next, the light emission characteristics when an amount of urea that is a raw material is changed will be described with reference to FIG. 4. FIG. 4 is a diagram for explaining an influence of the amount of urea in the phosphor according to Embodiment 1 (boric acid ratio dependence), and illustrates an emission spectrum of the phosphor. It should be noted that in this experiment, the annealing temperature is fixed at 1400° C. and for two hours, and only the amount of urea is changed. Moreover, a percentage value in FIG. 4 denotes a relative value of the amount of urea, defines the aforementioned standard condition (4.64 grams of urea with respect to 0.5 gram of boric acid) as 100%, and indicates an amount with respect to the amount of boric oxide.

As illustrated in FIG. 4, it is found that green emission is weak when no urea is included (0%) or when the amount of urea is small (for example, 20%). Moreover, in this case, it is found that central fluorescence wavelength shifts to the shortwave side and is near 500 nm. As described above, it is believed that the change of the central fluorescence wavelength to the shortwave side is originated from a host material.

Meanwhile, when the amount of urea is a standard condition (100%) or a further large amount of urea is added (for example, 450%), it is found that the central fluorescence wavelength shifts to the long wavelength side, the peak wavelength is about 520 nm, and intense light emission can be obtained. However, it is found that when a large amount of urea is added, the luminescence intensity is decreased. This is because it is believed that the compounding ratio of Eu is effectively decreased.

As described above, the phosphor can be observed as follows.

Boron oxynitride (BON) that is a host material is a mesh like compound of boron trioxide (B₂O₃) and boron nitride (BN).

Among them, boric oxide is a mesh like compound in which an equilateral triangle having oxygen at the top and boron in the center shares the top (oxygen) with another equilateral triangle. A bond distance between boron and oxygen is short with about 1.3 Å. Although boric oxide is patterned in mesh, it is believed that boron trioxide is relatively densely filled. Moreover, since boric oxide is a material very difficult to be crystallized, a melting point is relatively low at 450° C. Boric oxide maintains stoichiometry of boron:oxygen=2:3.

Meanwhile, boron nitride has a layer structure such as that of graphite carbon as the most stable crystalline structure, and maintains stoichiometry of boron:oxygen=1:1. It should be noted that although a bond distance between boron and nitrogen is almost the same as that between boron and oxygen, graphite-like boron nitride has a gap of several A with respect to a stacked direction of the layer structure.

When nitrogen is mixed into boric oxide, transformation occurs to the mesh structure of boric oxide due to a difference in valence. Especially in a region in which there is much nitrogen, it is expected that a gap is formed in the mesh structure of boric oxide. Moreover, through the incorporation of nitrogen, a band gap of boron oxynitride has a hem on the low energy side. When Eu is added, Eu complex is included in the gap generated by the addition of nitrogen, and it is believed that here functions as the luminescence center.

As described above, the phosphor according to Embodiment 1 comprises by adding a rare earth element to a material comprising oxide and nitride, and can obtain an emission spectrum having a high color purity of green. Therefore, it is possible to realize a phosphor having excellent color reproducibility.

Furthermore, in the phosphor, an emission spectrum has a narrow full width at half maximum and there is almost no emission spectrum in a wavelength that is beyond the human visual range, and light emission can be suppressed in a region having low visual sensitivity. Therefore, it is possible to realize a high efficient phosphor.

Furthermore, the phosphor is not affected by water because it does not include alkaline earth metal. Therefore, it is possible to realize a phosphor having excellent durability.

Moreover, although, in the phosphor according to the present embodiment, Eu is used as a rare earth metal, the rare earth metal is not limited to Eu. For example, it is possible to use at least one of the elements with atomic numbers from 58 to 71. With this rare earth element, without changing the host material, it is possible to realize various fluorescent colors.

Furthermore, in the phosphor according to the present embodiment, at least one element selected from the group consisting of Al, Si, C, P, S, Mg, Ca, Sr, Ba, and Zn may be contained in a host material as an accessory component. With this, it is possible to control an absorption spectrum of the host material itself. Moreover, since the bonding state surrounding the rare earth element can be changed, it is possible to fine-tune the fluorescence spectrum.

Moreover, in the phosphor according to the present embodiment, at least one element selected from the group consisting of Sc, Y, and La may be added, along with a rare earth element. With this, since a rare earth element can convert excitation energy, it is possible to increase conversion efficiency.

Moreover, although in the phosphor according to the present embodiment, boric acid, urea, and europium nitrate hexahydrate are used as a starting material for boron, nitrogen, oxygen, and europium, it is possible to use another raw material. For example, boric oxide can be used as a raw material for boron and oxygen. Since boric oxide has a low melting point of about 450° C., boric oxide can be completely melted at the annealing temperature in the present embodiment. Therefore, boric oxide can be used as a starting material for the phosphor. Although urea is described as a nitrogen raw material, anything can be used as long as it is a compound that can provide nitrogen capable of nitriding a host material. For example, there is azide such as ethyl azide and hydrazine compound such as hydrous hydrazine. These emit highly reactive nitrogen when they are dissolved, thus acting as nitriding of boric oxide. Moreover, europium carbonate hydrate or the like can be used as a material for europium. When using this, a carbonate group is dissolved in the annealing, and carbon is detached as carbon oxide or carbon dioxide. Then the remaining europium is incorporated into boron oxynitride that is a host. It should be noted that europium carbonate includes europium (II) and europium (III). Both of them can be used as a raw material. There are two reasons for this. One of the reasons is that since europium takes more stable (III) when it is hydrated, there is little influence on the valence of the starting material. Another of the reasons is that since an annealing condition is a reducing atmosphere in which oxygen is not included, there is little influence on the valence of the starting material.

Moreover, in the phosphor according to the present embodiment, the main fluorescence wavelength of the phosphor can be from 500 nm to 590 nm. With this, it is possible to convert light having low visual sensitivity from 370 nm to 490 nm to light having high visual sensitivity.

It should be noted that a method of manufacturing a phosphor according to the present embodiment is an example of the method of manufacturing the phosphor, and it is possible to manufacture the phosphor having the aforementioned configuration by changing the concentration and ratio of a raw material or an annealing condition.

A technique of nitriding by urea using the method of manufacturing the phosphor can be widely applied to other phosphors. The main point of the nitriding technique is that it is possible to burn a phosphor having higher nitrogen content as a starting material having low nitrogen content. It should be noted that the following cites a material that does not include nitrogen as a starting material. However, when a starting material that includes a lower concentration of nitrogen than that of the finished product is used, it is possible to obtain a phosphor having high nitrogen content.

First, for example, when AESiOₓ:RE (AE is at least one element selected from the group consisting of Mg, Ca, Sr, and Ba, and RE is at least one element selected from the group consisting of elements with atomic numbers 58 to 71) is a starting material, it is possible to obtain an AESiON:RE (oxygen does not necessarily have to be included) phosphor. For example, when nitriding burning using urea is performed on SrSiOₓ:Eu raw material, SrSiON:Eu red phosphor can be obtained. When nitriding burning using urea is performed on BaSiOₓ:Eu raw material, it is possible to obtain BaSiON phosphor that emits blue or green light.

Moreover, for example, when AlOₓ:RE (RE is at least one element selected from the group consisting of elements with atomic numbers 58 to 71) is a starting material, it is possible to obtain an AlON:RE (oxygen does not necessarily have to be included) phosphor. For example, when Eu is selected as RE, it is possible to obtain AlON:Eu green phosphor having high color purity (oxygen does not necessarily have to be included).

Moreover, when Eu is contained in a mixture of alumina and silica as an activator and then nitriding burning using urea is performed, it is possible to easily obtain a sialon phosphor. The sialon phosphor generally requires a high temperature of near 2000° C. in a burning process and high pressure of about 10 atmospheric pressure. However, since the nitriding technique by this urea makes it possible to obtain a sialon phosphor at normal pressure or at a low annealing temperature of about 1400° C., it is significantly effective in reducing cost.

As another example, when nitriding burning using urea is performed after alkaline earth salt that contains calcium carbonate as a main component (Cr, Ba, and Mg are cited other than Ca), alumina, and silica are mixed, Eu is contained as an activator, it is possible to easily obtain CASN phosphor. When nitriding burning using urea is performed after Ce is contained as an activator in a mixture of lanthanum oxide and silica, it is possible to easily obtain LaSiN:Ce phosphor that emits blue to green fluorescence. It should be noted that any one of alkaline earth elements (AE=Ca, Mg, Ba, and Sr; especially Ca is typical) is added to this raw material, it is possible to obtain LaAESiN:Ce phosphor that emits fluorescence having longer wavelength (yellow to red).

As a further example of application, in the existing oxide phosphor, a small part of oxygen can be used for being replaced with nitrogen. The nitrogen concentration should be suppressed at less than 5 mole % compared with oxygen as an amount to the extent that crystalline structure suitable for light emission in the oxide phosphor is not broken. When oxygen is replaced with nitrogen, a band gap of the host material can be changed and an emission wavelength of an activator can be changed. In most cases, it is possible to shift to the long wavelength side compared with the emission wavelength of the oxide phosphor.

For example, when part of oxygen in YAG:Ce phosphor is replaced with nitrogen, it is possible to change from yellow emission to orange or red emission. Moreover, part of Sr₃MgSi₂O₈:Eu or BaMgAl₁₀O₁₇:Eu is replaced with oxygen, blue emission can be converted into green emission.

A modulation technique of fluorescence wavelength by replacing part of oxygen with nitrogen produces an effect especially in an oxide phosphor having fluorescence life of less than 1 microsecond or full width at half maximum of fluorescence spectrum of no less than 40 nm. This is because a level of fluorescence in the activation element is mixed with the level of the host material. Due to the mixture with the level of the host material, forbidden transition of fluorescence is removed, fluorescence life is shorter, and full width at half maximum is wider. When part of oxygen is replaced with nitrogen in the host material, the influence is indicated by a change in fluorescence wavelength.

In the nitriding burning using urea of the phosphor, a gas supplying facility that is essential when ammonia is used, and a special furnace that can be resistant under high temperature and pressure are not necessary. Therefore, it is possible to operate cheaply and safely, and reduce a unit price of the phosphor as a result.

As described above, the use of the nitriding technique by urea makes it possible to easily obtain a phosphor having high nitrogen content from a starting material having low nitrogen concentration or containing no nitrogen.

In the aforementioned discussion, the phosphor obtained by nitriding burning through urea nitriding is represented that an activator such as Eu is added to a host material represented by MO(₁₋ₓ)Nₓ. Here, M is one or more elements selected from the group consisting of elements in Group IIA, Group IIIA, and Group IIIB, and M has a nitrogen composition x higher than that of a raw material before urea nitriding. It should be noted that x may be 1 (that is, does not include oxygen).

In this material system, an element represented by M is well incorporated as a host material after urea nitriding. Therefore, M is suitable for this urea nitriding method, and it is possible to efficiently manufacture high quality (oxy) nitride phosphor. It should be noted that the phosphor obtained from urea nitriding has narrower fluorescence full width at half maximum than the phosphor obtained from other burning methods, and tends to increase purity of color.

### Embodiment 2

Next, a light-emitting device according to Embodiment 2 will be described. It should be noted that the light-emitting device according to the present embodiment uses the phosphor according to Embodiment 1.

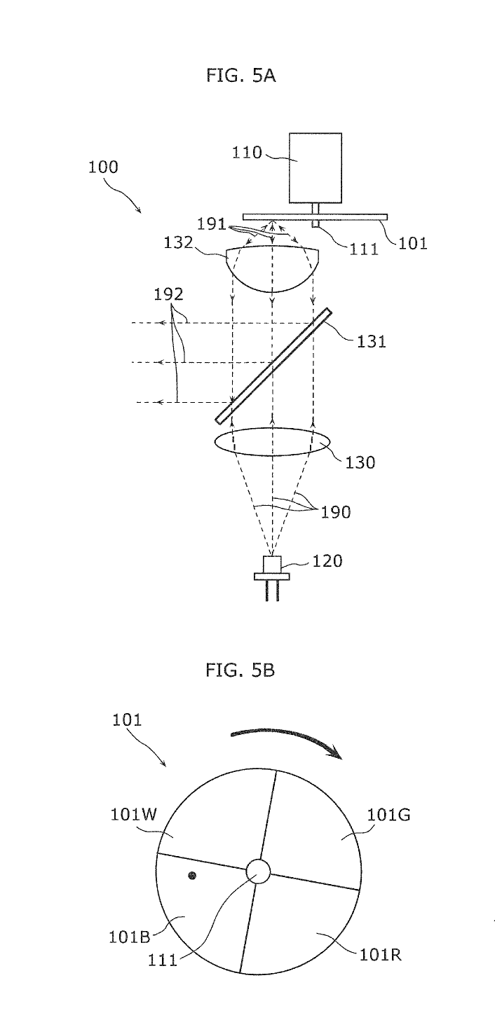

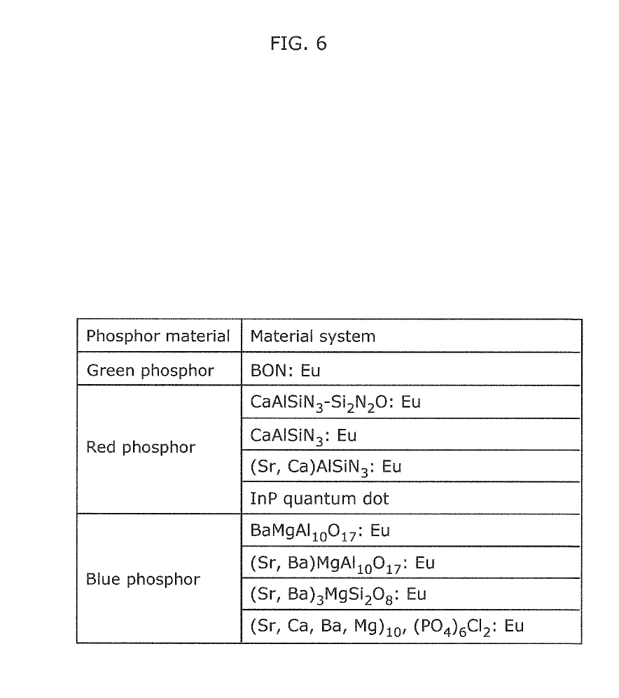

Next, a configuration of a light-emitting device 100 according to the present embodiment will be described with reference to FIG. 5A, FIG. 5B, and FIG. 6. FIG. 5A is a diagram illustrating a configuration of the light-emitting device according to Embodiment 2. FIG. 5B is a diagram illustrating a configuration of a phosphor wheel used in the light-emitting device, and is a diagram when the phosphor wheel is viewed from an incident side of light in FIG. 5A. FIG. 6 is a diagram for explaining a combination of phosphors used in the phosphor wheel.

The light-emitting device according to the present embodiment is a light-emitting device that includes a light-emitting element and a phosphor member including the phosphor according to Embodiment 1. Specifically, the light-emitting device 100 according to the present embodiment mainly includes, as illustrated in FIG. 5A, a light-emitting element 120 that emits excitation light, a collimate lens 130, a dichroic mirror 131, a light collecting lens 132, a phosphor wheel (phosphor member) 101, and a motor 110.

In the phosphor wheel, the axis of rotation 111 of the motor 110 is connected to a shaft hole provided at the center of the phosphor wheel 101, and is configured to rotate at a predetermined number of rotations by the drive of the motor 110. As illustrated in FIG. 5B, the phosphor wheel 101 is composed of a thin-disk shaped base comprising an aluminum plate having a thickness of about 1 mm, for example, and a phosphor layer is formed on its surface to which phosphor is applied at a predetermined thickness.

Moreover, since the light-emitting device 100 according to the present embodiment is used as light source of the non-illustrated projection display device, the phosphor wheel 101 has one or more regions divided according to the number of color types of the included phosphors and phosphor corresponding to different types of colors is applied to each region. In the present embodiment, the phosphor wheel 101 has, as illustrated in FIG. 5, four regions of a green phosphor region 101G, a red phosphor region 101R, a blue phosphor region 101B, a white phosphor region 101W. Each of the regions is painted with phosphor having a corresponding color. A phosphor material as illustrated in FIG. 6, for example, is used for the phosphor applied to each of the green phosphor region 101G, the red phosphor region 101R, the blue phosphor region 101B, and the white phosphor region 101W. It should be noted that the phosphor material is set to have a predetermined thickness by mixing with a binder such as silicone or low melting point glass

Specifically, the green phosphor region 101G is a region that mainly emits green wavelength fluorescence by excitation light from the light-emitting element 120. BON:Eu according to Embodiment 1 may be used for a phosphor material of this green phosphor region 101G, as illustrated in FIG. 6, as a green phosphor (first phosphor) having central fluorescence wavelength from 500 nm to 590 nm.

Moreover, the red phosphor region 101R is a region that mainly emits red wavelength fluorescence by excitation light from the light-emitting element 120. As illustrated in FIG. 6, phosphor such as quantum dot phosphor comprising InP nanoparticle, CaAlSiN₃—Si₂N₂O:Eu, CaAlSiN₃:Eu, or (Sr,Ca)AlSiN₃:Eu for a phosphor material of this red phosphor region 101R can be used as a red phosphor (second phosphor) having central fluorescence wavelength from 590 nm to 660 nm. It should be noted that CaAlSiN₃—Si₂N₂O:Eu can be manufactured by dissolving Si₂N₂O in CaAlSiN₃:Eu.

Moreover, the blue phosphor region 101B is a region that mainly emits blue wavelength fluorescence by excitation light from the light-emitting element 120. As illustrated in FIG. 6, phosphor such as BaMgAl₁₀O₁₇:Eu, (Sr,Ba)MgAl₁₀O₁₇:Eu, (Sr,Ba)₃MgSi₂O₈:Eu, or (Sr,Ca,Ba,Mg)₁₀, (PO₄)₆C₁₂:Eu can be used for a phosphor material of this blue phosphor region 101B as a blue phosphor (third phosphor) having central fluorescence wavelength from 430 nm to 500 nm.

Furthermore, the white phosphor region 101W is a region that mainly emits white wavelength fluorescence by excitation light from the light-emitting element 120. Phosphor obtained by mixing the green phosphor, the red phosphor, and the blue phosphor as illustrated in FIG. 6 at an appropriate ratio is applied to this white phosphor region 101W.

Next, a configuration of the light-emitting element 120 and the dichroic mirror 131 will be described.

The light-emitting element 120 is a light-emitting element that emits light having a main light emission wavelength from 350 nm to 490 nm, and is a laser diode that emits lights having wavelength of 400 nm, for example. The dichroic mirror 131, for example, is configured by forming, on the surface of a transparent substrate, a dielectric multilayer film that is optically designed to allow light having wavelength from 380 to 420 nm to pass through, and then allows light having wavelength of 420 to 700 nm to be reflected.

Next, an operation of the light-emitting device 100 according to the present embodiment will be described with reference to FIG. 5A and FIG. 5B.

As illustrated in FIG. 5A, emitted light 190 having wavelength of 400 nm emitted from the light-emitting element 120 becomes parallel light at the collimate lens 130, passes through the dichroic mirror 131, and is collected at a predetermined position of the surface of the phosphor wheel 101 by the light collecting lens 132.

The phosphor wheel 101 rotates at a predetermined number of rotations, and the emitted light 190 is irradiated to a predetermined phosphor region of the phosphor wheel 101 as illustrated in FIG. 5B (the green phosphor region 101G, the red phosphor region 101R, the blue phosphor region 101B, and the white phosphor region 101W). For example, when the emitted light 190 is irradiated to the blue phosphor region 101B, the emitted light 190 is converted into blue fluorescence 191 in the blue phosphor region 101B. Therefore, the blue fluorescence 191 is emitted from the blue phosphor region 101B.

The fluorescence 191 emitted from the phosphor wheel 101 goes in a direction opposite to that of the emitted light 190, is converted into parallel light by the light collecting lens 132, and is separated and reflected by the dichroic mirror 131, and then is emitted to outside the light-emitting device 100 as visible emitted light 192. For example, when the blue fluorescence 191 having wavelength from 430 nm to 500 nm is emitted from the phosphor wheel 101, this fluorescence 191 is reflected by the dichroic mirror 131 and is emitted as visible emitted light 192 to outside the light-emitting device 100.

It should be noted that when the emitted light 190 is irradiated to each of the green phosphor region 101G, the red phosphor region 101R, or the white phosphor region 101W of the phosphor wheel 101, each emitted light 190 is emitted as green fluorescence, red fluorescence, or white fluorescence from the light-emitting device 100.

As described above, the visible emitted light 192 from the light-emitting device 100 is emitted to outside the light-emitting device 100 when it becomes light changing from red, green, blue, white at every time. Therefore, by producing video according to the color of this visible emitted light 192, color video can be projected.

Moreover, the operation of the light-emitting device 100 will be described further in detail with reference to a spectrum of light emitted from the light-emitting device 100 and chromaticity coordinates of the spectrum.

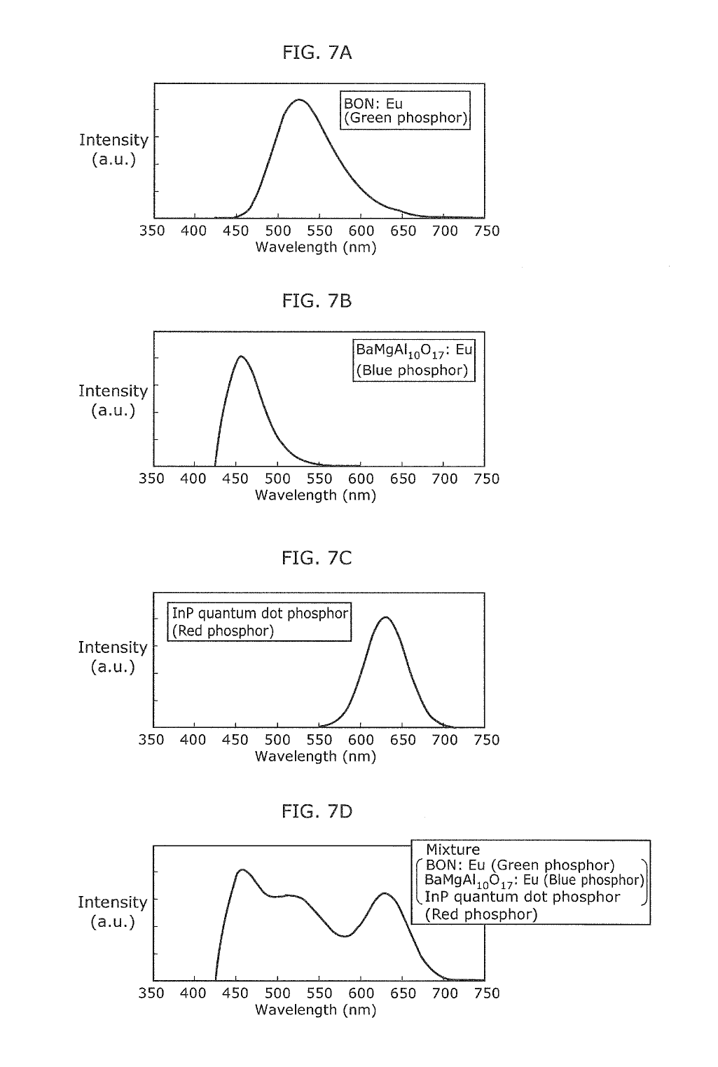

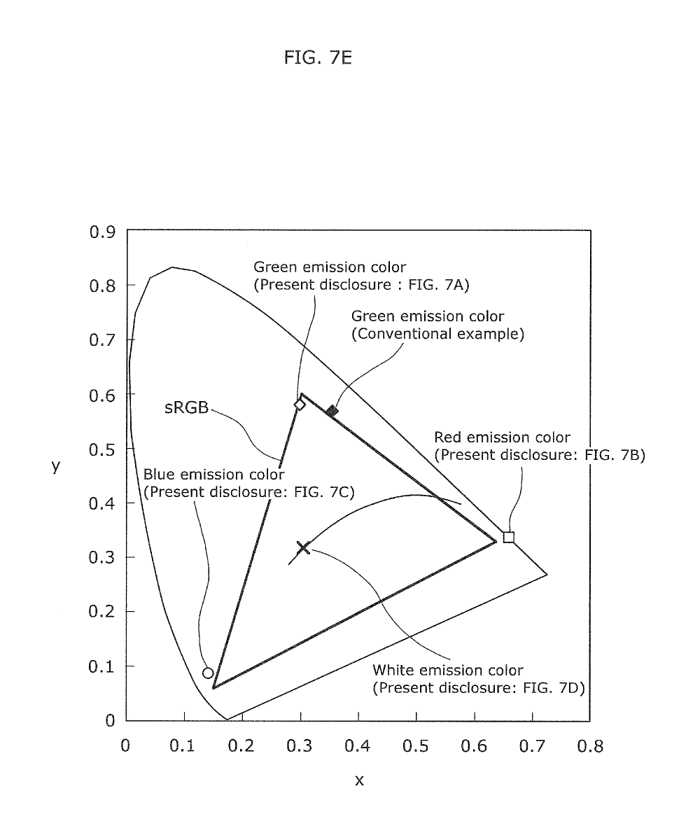

FIGS. 7A to 7D each illustrate a spectrum of light emitted from the light-emitting device according to Embodiment 2 (phosphor spectrum at a time of RGB excitation). FIG. 7A is a spectrum when green phosphor emits light in the case where BON:Eu according to the present embodiment is used as a phosphor. FIG. 7B is a spectrum when blue phosphor emits light in the case where BaMgAl₁₀O₁₇:Eu is used as a phosphor. FIG. 7C is a spectrum when red phosphor emits light in the case where InP quantum dot phosphor is used. FIG. 7D is a spectrum when white phosphor emits light in the case where it is designed so that white light is emitted by mixing the aforementioned green phosphor (BON:Eu), the blue phosphor (BaMgAl₁₀O₁₇:Eu), and the red phosphor (InP quantum dot phosphor) at an appropriate ratio. It should be noted that FIG. 7C indicates a spectrum that is similar in Gaussian distribution of an emission peak of 630 nm and a spectrum full width at half maximum of 60 nm. FIG. 7D indicates a color temperature of 7000 K, and white of chromaticity coordinates (0.307, 0.3167).

As described above, light having a spectrum as illustrated in FIGS. 7A to 7D is sequentially emitted from the light-emitting device 100 according to the rotation of the phosphor wheel 101.

Moreover, FIG. 7E is a diagram obtained by plotting, in a chromaticity diagram, chromaticity coordinates for respective colors in FIGS. 7A to 7D.

As illustrated in FIG. 7E, by using the phosphor according to the present embodiment, most of sRGB can be covered. Especially in green, green emission color in a conventional example as illustrated by ♦ in FIG. 7E (a value calculated from the spectrum illustrated in PTL 4) is displaced to the yellow side, and therefore green of the sRGB standard cannot be covered. Meanwhile, green emission color as illustrated by ⋄ in FIG. 7E is almost the same as chromaticity coordinates of green of sRGB, and it is found that this emission color is suitable for a phosphor used in the display device.

As described above, the light-emitting device 100 according to Embodiment 2 makes it possible to realize a light-emitting device that emits green light having good color reproducibility. Moreover, it is possible to realize a light-emitting device having high color rendering properties.

Moreover, in the present embodiment, a laser element is used as the light-emitting element 120. With this, since color conversion (wavelength conversion) can be performed on laser light, it is possible to realize a light-emitting device having higher color reproducibility.

It should be noted that in the present embodiment, the light-emitting element 120 is not limited to a laser diode (LD). For example, it is possible to use a semiconductor light-emitting element such as superluminescent diode (SLD). Moreover, the light-emitting element 120 may be obtained by optically combining a plurality of laser elements.

### Embodiment 3

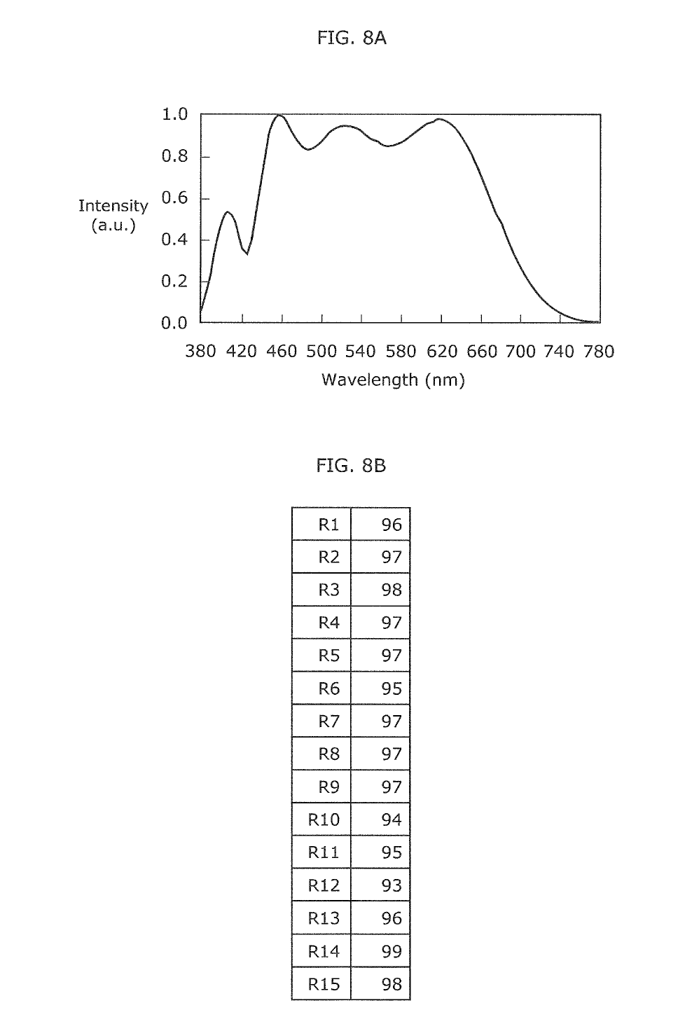

Next, a light-emitting device according to Embodiment 3 will be described with reference to FIG. 8A and FIG. 8B. It should be noted that in the present embodiment, the phosphor according to Embodiment 1 is used as a phosphor of a white light-emitting diode. FIG. 8A is a diagram illustrating a configuration of an emission spectrum of a light-emitting device (white light-emitting diode) according to Embodiment 3. FIG. 8B is a diagram illustrating a color rendering index of an emission spectrum of a light-emitting device (white light-emitting diode) according to Embodiment 3.

The light-emitting device according to the present embodiment is a white light-emitting device that includes a light-emitting element and a phosphor member including the phosphor according to Embodiment 1, and that emits white light. Specifically, the light-emitting device includes a resin package having a concave portion, a light-emitting element mounted on a bottom surface part of the concave portion of the resin package, a lead frame embedded in the bottom surface part of the concave portion, and a phosphor containing resin (phosphor member) filled in the concave portion to seal the LED.

In the present embodiment, a near-ultraviolet LED that emits near-ultraviolet light having an emission wavelength of about 400 nm is used as the light-emitting element. In other words, the light-emitting device according to the present embodiment is a ultraviolet excited white light-emitting diode.

Moreover, the phosphor containing resin comprises a phosphor and a silicone resin, for example. A mixture of three types of blue phosphor, green phosphor, and red phosphor can be used as the phosphor, for example. Here, the phosphor according to Embodiment 1 (BON:Eu) is used as a green phosphor. Moreover, the same phosphor as that in Embodiment 2 (BaMgAl₁₀O₁₇:Eu) is used as a blue phosphor. Moreover, (Sr,Ca)AlSiN₃:Eu is used as a red phosphor.

As described above, FIG. 8A is an example of an emission spectrum of the white light-emitting diode designed by mixing the amount of each of the blue phosphor, green phosphor, and red phosphor at a predetermined ratio. As illustrated in FIG. 8A, the emission spectrum of the light-emitting device according to the present embodiment has a color temperature of 5100 K and chromaticity coordinates (0.343, 0.353).

As illustrated in FIG. 8B, the color rendering index of the light-emitting device according to the present embodiment is no less than 93 from R1 to R15, and the average color rendering index (Ra) is 97.

As described above, the light-emitting device according to Embodiment 3 makes it possible to constitute a white light-emitting diode having significantly high color reproducibility and color rendering properties by using the phosphor according to Embodiments 1 and 2.

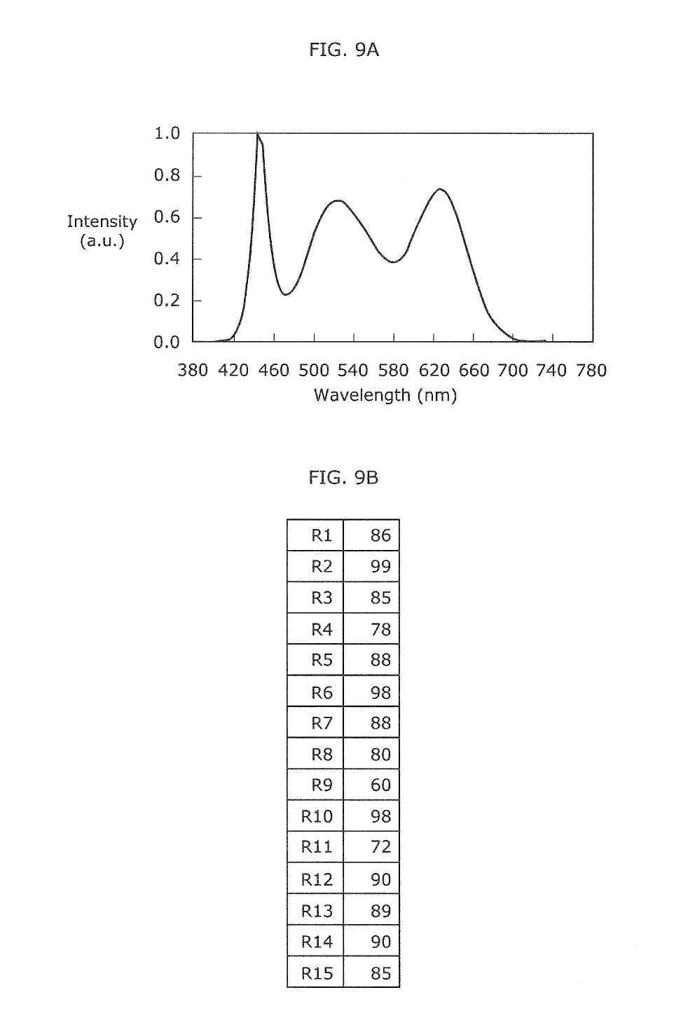

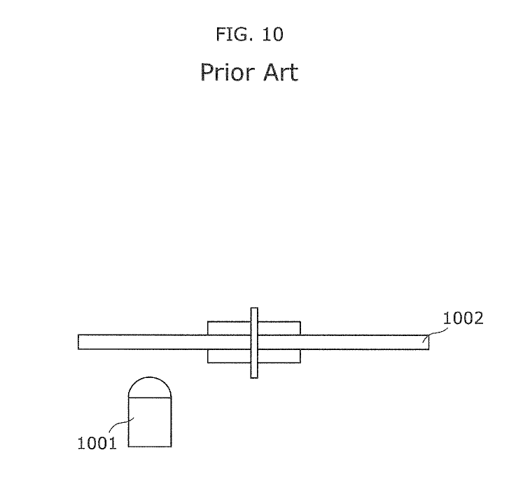

Next, a light-emitting device according to Modification of Embodiment 3 will be described with reference to FIG. 9A and FIG. 9B. FIG. 9A is a diagram illustrating an emission spectrum of a light-emitting device according to Modification to Embodiment 3. FIG. 9B is a diagram illustrating a color rendering index of the light-emitting device according to Embodiment 3.

The light-emitting device according to the present modification is different from the light-emitting device according to Embodiment 3 in light-emitting element and phosphor. Specifically, in the present modification, a blue light-emitting diode having an emission wavelength of about 450 nm is used as the light-emitting element. A mixture of a blue phosphor and a red phosphor is used as the phosphor. Here, the phosphor in Embodiment 1 (BON:Eu) is used as a green phosphor. Here, the phosphor having the same design as InP quantum dot phosphor in Embodiment 2 is used as a red phosphor. As described above, the light-emitting device according to the present embodiment is a blue excited white light-emitting diode.

As described above, FIG. 9A is an example of an emission spectrum of the white light-emitting diode obtained by optimizing and mixing the amount of each of the green phosphor and red phosphor at a predetermined ratio. As illustrated in FIG. 9A, the emission spectrum of the light-emitting device according to the present modification has a color temperature of 5000 K and chromaticity coordinates (0.344, 0.357).

As illustrated in FIG. 9B, the color rendering index of the light-emitting device according to the present embodiment is no less than 60 in each of R1 to R15, and the average color rendering index (Ra) is 88.

As described above, the light-emitting device according to Embodiment 3 makes it possible to constitute a white light-emitting diode having significantly high color reproducibility by using the phosphor according to Embodiments 1 and 2.

It should be noted that the phosphor used in Embodiment 3 is not limited to the phosphor in the present embodiment. By appropriately selecting the other blue phosphor and red phosphor, it is possible to realize a light-emitting device having high color reproducibility for different purposes.

As described above, the phosphor and the light-emitting device according to the present disclosure have been described based on Embodiments 1 to 3, the present disclosure is not limited to these embodiments. Various modifications that may be conceived by those skilled in the art are intended to be included within the scope of the present disclosure. Furthermore, respective structural elements of different embodiments without departure from the essence of the present disclosure may be arbitrarily combined within the scope of the essence of the present disclosure.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of the present disclosure.

### INDUSTRIAL APPLICABILITY

A phosphor and a light-emitting device according to the present disclosure are widely applicable to a light source for various devices such as a lighting device and a display.

1. A phosphor represented by chemical formula MO(₁₋ₓ)Nₓ:RE,
wherein M is at least one element selected from a group consisting of elements in Group iiA, Group IIIA, and Group IIIB,
nitrogen composition x is a value that is larger than 0 and is not larger than 1, and
RE is at least one element selected from a group consisting of elements with atomic numbers from 58 to 71.

2. The phosphor according to claim 1,
wherein MO(₁₋ₓ)Nₓ in the chemical formula is a main component of a host material,
RE in the chemical formula is a rare earth element to be added to the host material, and
the phosphor has a central fluorescence wavelength in a green region.

3. The phosphor according to claim 2,
wherein the host material includes, as an accessory component, at least one element selected from a group consisting of Al, Si, C, P, S, Mg, Ca, Sr, Ba, and Zn.

4. The phosphor according to claim 1,
wherein M in the chemical formula includes at least one element selected from a group consisting of Sc, Y, and La.

5. The phosphor according to claim 1,
wherein the phosphor has a main fluorescence wavelength from 500 nm to 590 nm.

6. A light-emitting device comprising:
a light-emitting element having a main light emission wavelength from 350 nm to 490nm; and a phosphor member, wherein the phosphor member includes the phosphor according to claim 1.

7. The light-emitting device according to claim 6,
wherein the phosphor member further includes, as a second phosphor, a phosphor having a main fluorescence wavelength from 590 nm to 660 nm.

8. The light-emitting device according to claim 7,
wherein the phosphor member further includes, as a third phosphor, a phosphor having a main fluorescence wavelength from 430 nm to 500 nm.

9. The light-emitting device according to claim 8,
wherein the phosphor member has one or more regions divided according to a type of the included phosphor.

10. The light-emitting device according to claim 7,
wherein the second phosphor is obtained by dissolving Si₂N₂O in a quantum dot phosphor, CaAlSiN₃:Eu, (Sr,Ca)AlSiN₃:Eu, or CaAlSiN₃:Eu.

11. The light-emitting device according to claim 8,
wherein the third phosphor is any one of (Ba,Sr)MgAl₁₀O₁₇:Eu, (Sr,Ca,Ba,Mg)₁₀,(PO₄)₆Cl₂:Eu, and (Sr,Ba)₃MgSi₂O₈:Eu.

12. The light-emitting device according to claim 6,
wherein the light-emitting element is a semiconductor laser diode.

13. The light-emitting device according to claim 1,
wherein the phosphor is produced by a manufacturing procedure including a nitriding process that uses urea as a nitrogen raw material.
